(19) United States
(12) Patent Application Publication
(10) Pub. No.: US 2023/0387522 A1
(43) Pub. Date: Nov. 30, 2023

(54) METHOD OF MANUFACTURING SECONDARY BATTERY

(71) Applicant: MURATA MANUFACTURING CO., LTD., Kyoto (JP)

(72) Inventor: Teppei AKIYOSHI, Kyoto (JP)

(21) Appl. No.: 18/233,053

(22) Filed: Aug. 11, 2023

Related U.S. Application Data
(63) Continuation of application No. PCT/JP2022/006444, filed on Feb. 17, 2022.

(30) Foreign Application Priority Data
Feb. 18, 2021 (JP) 2021-024486

(51) Int. Cl. H01M 50/169; H01M 10/0525

(52) U.S. Cl. CPC H01M 50/169; H01M 10/0525

(57) ABSTRACT

A method of manufacturing a secondary battery is provided and includes providing an electrode assembly in a cup-shaped exterior member; injecting an electrolytic solution into the cup-shaped exterior member; providing the lid-shaped exterior member so as to cover a cavity of the cup-shaped exterior member with a lid and to be fitted into at least a part of the cavity; and irradiating a boundary portion between the cup-shaped exterior member and the lid-shaped exterior member with laser to form a welded portion. In particular, in an embodiment, each of the cup-shaped exterior member and the lid-shaped exterior member includes a first extending surface constituting a boundary portion and a second extending surface facing the first extending surface while being spaced apart from each other, and the laser is emitted from one second extending surface of the cup-shaped exterior member and the lid-shaped exterior member to the other second extending surface of the cup-shaped exterior member and the lid-shaped exterior member with the boundary portion interposed therebetween.

### CROSS REFERENCE TO RELATED APPLICATIONS

The present application is a continuation of PCT patent application no. PCT/JP2022/006444, filed on Feb. 17, 2022, which claims priority to Japanese patent application no. 2021-024486, filed on Feb. 18, 2021, the entire contents of which are incorporated herein by reference.

### BACKGROUND

The present application relates to a secondary battery and a method of manufacturing the same. More specifically, the present application relates to a method of manufacturing a secondary battery including an electrode assembly including a positive electrode, a negative electrode, and a separator.

Secondary batteries are so-called storage batteries and therefore can be repeatedly charged and discharged, and the secondary batteries are used in various applications. For example, secondary batteries are used for mobile devices such as mobile phones, smart phones and notebook

### SUMMARY

Conventional secondary batteries have problems to be overcome, for example, as noted below (refer to FIG. 11).

The secondary battery includes an electrode assembly including a positive electrode, a negative electrode, and a separator therebetween, and an exterior body 50′ enclosing the electrode assembly 10′. The exterior body of the secondary battery includes, for example, two exterior members (a cup-shaped member and a lid-shaped member) connected to each other by a welded portion 20′.

The welded portion 20′ may be formed, for example, by arranging a lid-shaped exterior member 52′ to be fitted into the cavity of a cup-shaped exterior member 51′ and irradiating a boundary portion 53′ between an end portion of the lid-shaped exterior member 52′ and an end portion of the cup-shaped exterior member 51′ with a laser L′. The laser L′ is usually emitted along an extending direction of the boundary portion 53′ between the lid-shaped exterior member 52′ and the cup-shaped exterior member 51′ positioned at the boundary portion 53′.

Since the laser L′ is emitted along the extending direction of the boundary portion 53′, a sputter 90′ easily enters an electrode assembly 10′ through the boundary portion 53′. The entry of the sputter 90′ into the electrode assembly 10′ may damage the electrode assembly 10′, leading to deterioration of battery characteristics.

The present application relates to providing a method of manufacturing a secondary battery capable of preventing a sputter generated at the time of welding an exterior member by laser from entering an electrode assembly according to an embodiment.

In an embodiment, the present application provides a method of manufacturing a secondary battery,
the method including the steps of:
providing an electrode assembly in a cup-shaped exterior member;
injecting an electrolytic solution into the cup-shaped exterior member;
providing a lid-shaped exterior member so as to cover a cavity of the cup-shaped exterior member with a lid and to be fitted into at least a part of the cavity; and
irradiating a boundary portion between the cup-shaped exterior member and the lid-shaped exterior member facing each other with laser to form a welded portion, by providing the lid-shaped exterior member,
wherein:
each of the cup-shaped and lid-shaped exterior members includes a first extending surface constituting the boundary portion and a second extending surface facing the first extending surface while being spaced apart from each other, and
the laser is emitted from the second extending surface of one of the cup-shaped and lid-shaped exterior members toward the second extending surface of the other of the cup-shaped and lid-shaped exterior members with the boundary portion interposed therebetween.

According to a method of manufacturing a secondary battery according to an embodiment of the present application, it is possible to prevent a sputter generated at the time of welding an exterior member by laser from entering an electrode assembly.

### BRIEF DESCRIPTION OF THE FIGURES

FIG. 1A is a schematic sectional view illustrating a step of installing an electrode assembly inside a cup-shaped exterior member in a method of manufacturing a secondary battery according to an embodiment of the present application.

FIG. 1B is a schematic sectional view illustrating a step of connecting a current collecting tab drawn out from an electrode assembly and an external connection terminal provided on a lid-shaped exterior member in the method of manufacturing a secondary battery according to an embodiment of the present application.

FIG. 1C is a schematic sectional view illustrating a step of injecting an electrolytic solution of the method of manufacturing a secondary battery according to an embodiment of the present application.

FIG. 1D is a schematic sectional view illustrating a step of providing the lid-shaped exterior member so as to cover a cavity of the cup-shaped exterior member with a lid and to be fitted into at least a part of the cavity, and irradiating a boundary portion between the cup-shaped exterior member and the lid-shaped exterior member facing each other with laser to form a welded portion, in the method of manufacturing a secondary battery according to an embodiment of the present application.

FIG. 2 is an enlarged schematic sectional view of FIG. 1D.

FIG. 3 is an enlarged schematic sectional view illustrating a step of forming a welded portion when laser irradiation direction is different from laser irradiation direction illustrated in FIG. 1D.

FIG. 4 is a schematic perspective view illustrating a specific configuration of a secondary battery obtained in accordance with the method of manufacturing a secondary battery according to an embodiment of the present application.

FIG. 5 is a schematic sectional view illustrating a specific configuration of a secondary battery obtained in accordance with the method of manufacturing a secondary battery according to an embodiment of the present application.

FIG. 6 is a schematic sectional view illustrating a state in which a force is applied to an outer peripheral edge portion forming the cavity of the cup-shaped exterior member when the cavity of the cup-shaped exterior member is covered with a lid and the lid-shaped exterior member is provided so as to be fitted into at least a part of the cavity.

FIG. 7 is a schematic sectional view illustrating an aspect in which a lid-shaped exterior member having a protruding portion is used.

FIG. 8 is a schematic sectional view illustrating an aspect in which a cup-shaped exterior member having a step portion is used.

FIG. 9 is a schematic sectional view illustrating an aspect in which an outer peripheral edge portion forming a cavity is curved so as to be separated from a rising side portion of a lid-shaped exterior member is used as a cup-shaped exterior member.

FIG. 10A is a sectional view schematically illustrating an electrode-constituting layer having a planar stacked structure.

FIG. 10B is a sectional view schematically illustrating an electrode-constituting layer having a wound structure.

FIG. 11 is a sectional view schematically illustrating an aspect in which laser is emitted along an extending direction of a boundary portion between an end portion of the cup-shaped exterior member and an end portion of the lid-shaped exterior member.

### DETAILED DESCRIPTION

A method of manufacturing a secondary battery according to an embodiment of the present application will be described below in more detail. Although the description will be made with reference to the drawings if necessary, various elements in the drawings are only schematically and exemplarily illustrated for the understanding of the present application, and appearances and/or dimensional ratios may be different from actual ones.

The term “sectional view” directly or indirectly described in the present description is based on a virtual cross section obtained by cutting the secondary battery along the height direction. The terms “vertical direction” and “horizontal direction” directly or indirectly used in the present description respectively correspond to a vertical direction and a horizontal direction in the drawings. Unless otherwise specified, the same reference symbols or signs indicate the same members or parts or the same semantic contents. According to a preferred aspect, it can be understood that a downward direction in a vertical direction (that is, a direction in which gravity acts) corresponds to a “downward direction”, whereas the opposite direction corresponds to an “upward direction”.

The term “secondary battery” as used in the present specification refers to a battery that can be repeatedly charged and discharged. Accordingly, the secondary battery according to the present application is not excessively limited by its name, and for example, an “electric storage device and the like can also be included in the subject of the present application.

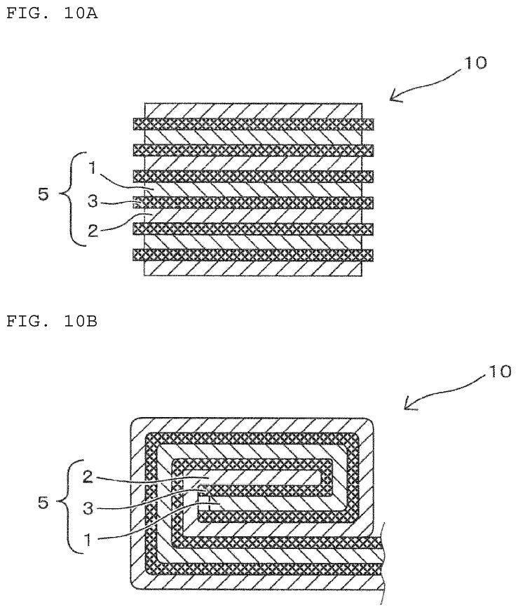

The secondary battery according to an embodiment of the present application includes an electrode assembly formed by stacking electrode-constituting layers including a positive electrode, a negative electrode, and a separator. FIGS. 10A and 10B illustrate an electrode assembly 10. As illustrated in FIG. 10A and FIG. 10B, a positive electrode 1 and a negative electrode 2 are stacked with a separator 3 interposed therebetween to form an electrode-constituting layer 5, and at least one or more of the electrode-constituting layers 5 are stacked to configure the electrode assembly. FIG. 10A illustrates a planar stacked structure in which the electrode-constituting layers 5 are stacked in a planar shape without being wound. Meanwhile, FIG. 10B illustrates a wound stacked structure in which the electrode-constituting layer 5 is wound in a wound shape. That is, FIG. 10B illustrates a wound structure in which an electrode-constituting layer including a positive electrode, a negative electrode, and a separator disposed between the positive electrode and the negative electrode is wound in a roll shape. For the secondary battery, such an electrode assembly is enclosed together with an electrolyte (for example, a non-aqueous electrolyte) in an exterior body. The structure of the electrode assembly is not necessarily limited to the planar stacked structure or the wound structure. For example, the electrode assembly may have a so-called stack-and-folding type structure in which a positive electrode, a separator, and a negative electrode are stacked on a long film and then folded.

The positive electrode is composed of at least a positive electrode material layer and a positive electrode current collector. In the positive electrode, the positive electrode material layer is provided on at least one surface of the positive electrode current collector. The positive electrode material layer contains a positive electrode active material as an electrode active material. For example, for the plurality of positive electrodes in the electrode assembly, for each of the electrodes, the positive electrode material layer may be provided on both sides of the positive electrode current collector, or may be provided only on one side of the positive electrode current collector.

The negative electrode is composed of at least a negative electrode material layer and a negative electrode current collector. In the negative electrode, the negative electrode material layer is provided on at least one surface of the negative electrode current collector. The negative electrode material layer contains a negative electrode active material as an electrode active material. For example, for the plurality of negative electrodes in the electrode assembly, for each of the electrodes, the negative electrode material layer may be provided on both sides of the negative electrode current collector, or may be provided only on one surface of the negative electrode current collector.

The electrode active material contained in the positive electrode and the negative electrode, that is, the positive electrode active material and the negative electrode active material are substances directly involved in the transfer of electrons in the secondary battery, and are main substances of the positive and negative electrodes which are responsible for charging and discharging, that is, a battery reaction. More specifically, ions are brought in the electrolyte due to the “positive electrode active material contained in the positive electrode material layer” and the “negative electrode active material contained in the negative electrode material layer”, and such ions move between the positive electrode and the negative electrode to transfer electrons, thereby performing charging and discharging. The positive electrode material layer and the negative electrode material layer may be layers particularly capable of occluding and releasing lithium ions. More specifically, the secondary battery according to the present application may be a non-aqueous electrolyte secondary battery in which lithium ions move between the positive electrode and the negative electrode through a non-aqueous electrolyte, thereby charging and discharging the battery. When lithium ions are involved in charging and discharging, the secondary battery according to the present application corresponds to a so-called “lithium ion battery”, and the positive electrode and the negative electrode include a layer capable of occluding and releasing lithium ions.

When the positive electrode active material of the positive electrode material layer is composed of, for example, a granular material, a binder may be included in the positive electrode material layer for more sufficient contact between the particles and shape retention. Furthermore, a conductive auxiliary agent may be included in the positive electrode material layer to facilitate the transfer of electrons promoting a battery reaction. Similarly, when the negative electrode active material of the negative electrode material layer is composed of, for example, a granular material, a binder may be contained in order to maintain a more sufficient contact between particles and the shape of the particles, and a conductive auxiliary agent may be contained in the negative electrode material layer in order to facilitate transmission of electrons promoting the battery reaction. As described above, since a plurality of components are contained, the positive electrode material layer and the negative electrode material layer can also be referred to as “positive electrode mixture layer” and “negative electrode mixture layer”, respectively.

The positive electrode active material may be a material that contributes to occlusion and release of lithium ions. From such a viewpoint, the positive electrode active material may be, for example, a lithium-containing composite oxide. More specifically, the positive electrode active material may be a lithium transition metal composite oxide containing lithium and at least one transition metal selected from a group consisting of cobalt, nickel, manganese, and iron. More specifically, in the positive electrode material layer of the secondary battery according to the present application, such a lithium transition metal composite oxide is preferably included as a positive electrode active material. For example, the positive electrode active material may be lithium cobaltate, lithium nickelate, lithium manganate, lithium iron phosphate, or a material obtained by replacing a part of the transition metals with another metal. Such a positive electrode active material may be included as a single species, or two or more species may be included in combination.

The binder which can be contained in the positive electrode material layer is not particularly limited, but examples thereof include at least one selected from the group consisting of polyvinylidene fluoride, a vinylidene fluoride-hexafluoropropylene copolymer, a vinylidene fluoride-tetrafluoroethylene copolymer, and polytetrafluoroethylene and the like. The conductive auxiliary agent that can be contained in the positive electrode material layer is not particularly limited, but examples thereof can include at least one selected from carbon blacks such as thermal black, furnace black, channel black, ketjen black, and acetylene black, carbon fibers such as graphite, carbon nanotube, and vapor-grown carbon fiber, metal powders such as copper, nickel, aluminum, and silver, and polyphenylene derivatives.

The thickness dimension of the positive electrode material layer is not particularly limited, and may be 1 μm or more and 300 μm or less, and is, for example, 5 μm or more and 200 μm or less. The thickness dimension of the positive electrode material layer is a thickness inside the secondary battery, and the average value of measured values at random 10 points may be employed.

The negative electrode active material may be a material that contributes to occlusion and release of lithium ions. From such a viewpoint, the negative electrode active material may be, for example, various carbon materials, oxides, and/or lithium alloys.

Examples of various carbon materials for the negative electrode active material can include graphite (natural graphite and/or artificial graphite), hard carbon, soft carbon, and/or diamond-like carbon. Particularly, graphite has high electron conductivity and excellent adhesiveness to the negative electrode current collector. Examples of the negative electrode active material include at least one selected from the group consisting of silicon, silicon oxide, titanium oxide-based materials such as tin oxide, tin alloy, and lithium titanate, metallic lithium, indium oxide, zinc oxide and lithium alloy, and silicon alloy. The lithium alloy of the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, and La. Such an active material may be amorphous as its structural form. This is because deterioration due to nonuniformity such as crystal grain boundaries or defects is less likely to be caused.

The binder which can be contained in the negative electrode material layer is not particularly limited, but examples thereof include at least one kind selected from the group consisting of styrene-butadiene rubber, polyacrylic acid, polyvinylidene fluoride, polyimide-based resin, and polyamideimide-based resin. For example, the binder contained in the negative electrode material layer may be styrene butadiene rubber. The conductive auxiliary agent that can be contained in the negative electrode material layer is not particularly limited, but examples thereof can include at least one selected from carbon blacks such as thermal black, furnace black, channel black, ketjen black, and acetylene black, carbon fibers such as graphite, carbon nanotube, and vapor-grown carbon fiber, metal powders such as copper, nickel, aluminum and silver, and polyphenylene derivatives. It is to be noted that the negative electrode material layer may include therein a component derived from a thickener component (for example, carboxymethyl cellulose) used in the manufacture of the battery.

The thickness dimension of the negative electrode material layer is not particularly limited, but may be 1 μm or more and 300 μm or less, and is, for example, 5 μm or more and 200 μm or less. The thickness dimension of the negative electrode material layer is a thickness inside the secondary battery, and the average value of measured values at random 10 points may be employed.

The positive electrode current collector and the negative electrode current collector used for the positive electrode and the negative electrode are members configured to contribute to collecting and supplying electrons generated in the electrode active material due to the battery reaction. Such an electrode current collector may be a sheet-like metal member. Further, the electrode current collector may have a porous or perforated form. For example, the current collector may be a metal foil, a punching metal, a net or an expanded metal, or the like. The positive electrode current collector used for the positive electrode is preferably made of a metal foil containing at least one selected from the group consisting of aluminum, stainless steel, and nickel, and may be, for example, an aluminum foil. On the other hand, the negative electrode current collector used for the negative electrode is preferably made of a metal foil containing at least one selected from the group consisting of copper, stainless steel, nickel, and the like, and may be, for example, copper foil.

The thickness dimension of each of the positive electrode current collector and the negative electrode current collector is not particularly limited, and may be 1 μm or more and 100 μm or less, and is, for example, 10 μm or more and 70 μm or less. The thickness dimension of each of the positive electrode current collector and the negative electrode current collector is a thickness inside the secondary battery, and the average value of measured values at random 10 points may be employed.

The separator used for the positive electrode and the negative electrode is a member provided from the viewpoints of the prevention of short circuit due to contact between the positive and negative electrodes and the holding of the electrolyte and the like. In other words, it can be said that the separator is a member configured to allow ions to pass while preventing electronic contact between the positive electrode and the negative electrode. For example, the separator is a porous or microporous insulating member, and has a membrane form due to its small thickness. As a mere example, a microporous membrane made of polyolefin may be used as the separator. In this respect, the microporous membrane used as the separator may contain, for example, only polyethylene (PE) or only polypropylene (PP) as polyolefin. Further, the separator may be a laminate including “a microporous membrane made of PE” and “a microporous membrane made of PP”. The surface of the separator may be covered with an inorganic particle coating layer, and/or an adhesive layer. The surface of the separator may have adhesion. Further, in the present application, the separator is not to be particularly limited by its name, and may be solid electrolytes, gel electrolytes, and/or insulating inorganic particles that have a similar function.

The thickness dimension of the separator is not particularly limited, and may be 1 μm or more and 100 μm or less, and is, for example, 2 μm or more and 20 μm or less. The thickness dimension of the separator is a thickness inside the secondary battery (particularly, the thickness between the positive electrode and the negative electrode), and the average value of measured values at random 10 points may be employed.

In the secondary battery according to an embodiment of the present application, an electrode assembly including an electrode-constituting layer including a positive electrode, a negative electrode, and a separator may be enclosed in an exterior body together with an electrolyte. The electrolyte may be a “non-aqueous” electrolyte containing an organic electrolyte, an organic solvent, and the like, or may be an “aqueous” electrolyte containing water. When the positive electrode and the negative electrode include a layer capable of occluding and releasing lithium ions, the electrolyte is preferably “a non-aqueous” electrolyte such as an organic electrolyte or an organic solvent. That is, the electrolyte preferably serves as a non-aqueous electrolyte. In the electrolyte, metal ions released from the electrode (the positive electrode and/or the negative electrode) are present, and therefore the electrolyte can assist the movement of metal ions in the battery reaction. It is to be noted that the electrolyte may have a form such as a liquid form or a gel form.

The non-aqueous electrolyte is an electrolyte including a solvent and a solute. The solvent may be an organic solvent. The specific organic solvent of the non-aqueous electrolyte may contain at least a carbonate. The carbonate may be a cyclic carbonate and/or a chain carbonate. Although not particularly limited, examples of the cyclic carbonates include at least one selected from the group consisting of a propylene carbonate (PC), an ethylene carbonate (EC), a butylene carbonate (BC), and a vinylene carbonate (VC). Examples of the chain carbonate include at least one selected from the group consisting of a dimethyl carbonate (DMC), a diethyl carbonate (DEC), an ethyl methyl carbonate (EMC), and a dipropyl carbonate (DPC). By way of an example only, combinations of cyclic carbonates and chain carbonates may be used as the non-aqueous electrolyte, and for example, a mixture of an ethylene carbonate and a diethyl carbonate may be used. As a specific solute for the nonaqueous electrolyte, for example, Li salts such as LiPF₆ and/or LiBF₄ may be used.

The exterior body of the secondary battery is a member enclosing an electrode assembly formed by stacking electrode-constituting layers including a positive electrode, a negative electrode, and a separator. The exterior body may be made of at least one metal selected from the group consisting of stainless steel (SUS), aluminum, and iron. The term “stainless steel” in the present specification refers to, for example, stainless steel defined in “JIS G 0203 Glossary of terms used in iron and steel”, and may be chromium or alloy steel containing chromium and nickel.

Hereinafter, the present will be described in further detail according to an embodiment.

The present application relates to providing a solution for presenting the sputter generated at the time of welding the exterior member by the laser from entering the electrode assembly according to an embodiment. In an embodiment, a method of manufacturing a secondary battery is provided.

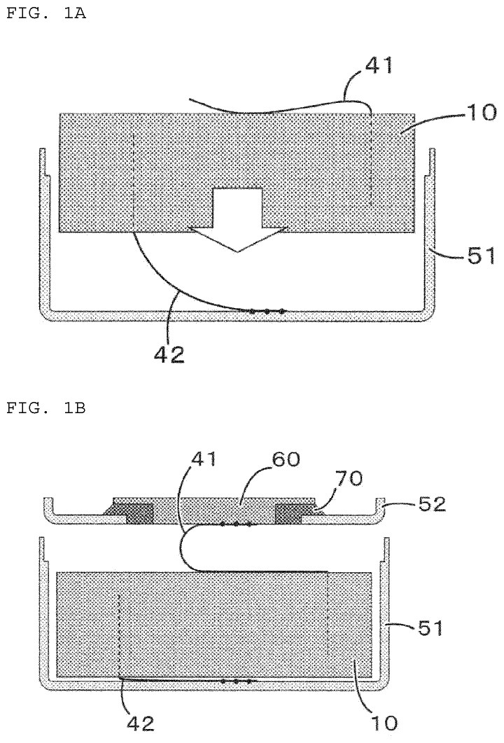

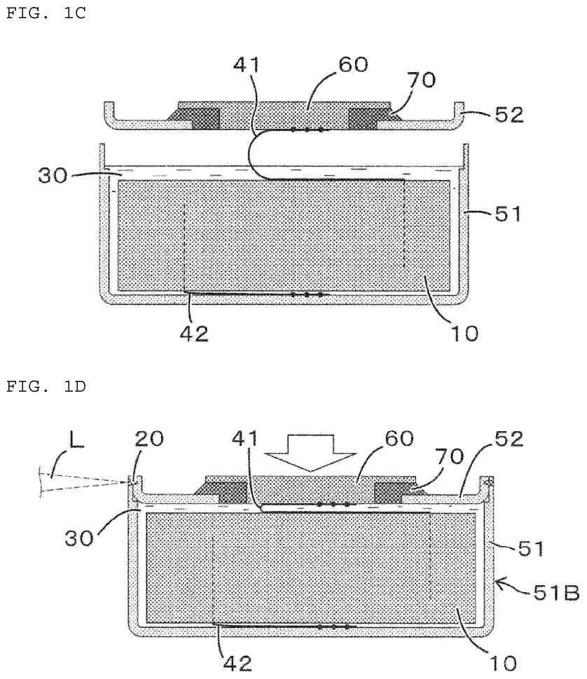

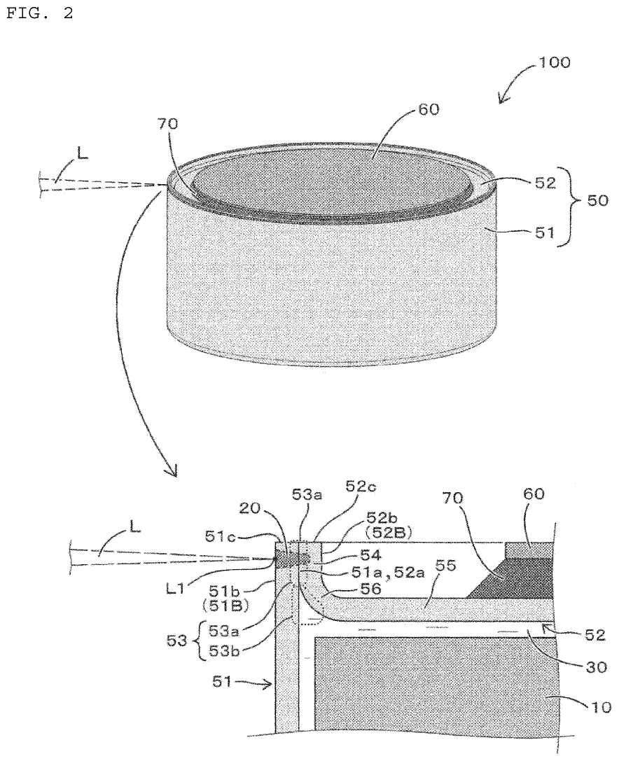

FIG. 1A is a schematic sectional view illustrating a step of installing an electrode assembly inside a cup-shaped exterior member in the method of manufacturing a secondary battery according to an embodiment of the present application. FIG. 1B is a schematic sectional view illustrating a step of connecting a current collecting tab drawn out from an electrode assembly and an external connection terminal provided on a lid-shaped exterior member in the method of manufacturing a secondary battery according to an embodiment of the present application. FIG. 1C is a schematic sectional view illustrating a step of injecting an electrolytic solution of the method of manufacturing a secondary battery according to an embodiment of the present application. FIG. 1D is a schematic sectional view illustrating a step of forming a welded portion by providing the lid-shaped exterior member so as to cover a cavity of the cup-shaped exterior member with a lid and to be fitted into at least a part of the cavity, and irradiating a boundary portion between the cup-shaped exterior member and the lid-shaped exterior member facing each other with laser in the method of manufacturing a secondary battery according to an embodiment of the present application. FIG. 2 is an enlarged schematic sectional view of FIG. 1D. FIG. 3 is an enlarged schematic sectional view illustrating a step of forming a welded portion when laser irradiation direction is different from laser irradiation direction illustrated in FIG. 1D.

The method of manufacturing a secondary battery according to an embodiment of the present application includes, for example, the following steps (i) to (iv) in order:
(i) a step of providing an electrode assembly 10 in a cup-shaped exterior member 51 (refer to FIG. 1A);
(ii) a step of injecting an electrolytic solution 30 into the cup-shaped exterior member 51 (refer to FIG. 1C);
(iii) a step of providing a lid-shaped exterior member 52 so as to cover a cavity of the cup-shaped exterior member 51 with a lid and to be fitted into at least a part of the cavity (FIG. 1D); and
(iv) a step of irradiating a boundary portion 53 between the cup-shaped exterior member 51 and the lid-shaped exterior member 52 facing each other with laser L to form a welded portion 20, by providing the lid-shaped exterior member (refer to FIG. 1D).

The method of manufacturing a secondary battery according to an embodiment is characterized in the step (iv) among the above steps. Specifically, each of the cup-shaped exterior member 51 and the lid-shaped exterior member 52 includes the first extending surfaces 51a and 52a constituting the boundary portion 53 and the second extending surfaces 51b and 52b facing the first extending surfaces 51a and 52a while being spaced apart from each other, and the laser L is emitted from one second extending surface of the cup-shaped exterior member 51 and the lid-shaped exterior member 52 to the other second extending surface of the cup-shaped exterior member 51 and the lid-shaped exterior member 52 with the boundary portion 53 interposed therebetween (refer to FIGS. 1D and 2). That is, when the welded portion 20 is formed, the welded portion 20 is formed by irradiating the laser L across the boundary portion 53. In other words, when the welded portion 20 is formed, the laser L is emitted so as to cross the boundary portion 53.

The “cup-shaped exterior member” as used in the present specification means a member that includes a side wall or a side surface corresponding to a body portion and a main surface (in a typical mode, for example, a bottom portion) continuous with the side wall or the side surface, and in which a hollow portion is formed. As illustrated in FIG. 2, the cup-shaped exterior member 51 may be circular. The “circular shape” as used herein is not limited to a perfect circular shape (that is, simply a “circle” or a “perfect circle”), and includes a substantially circular shape that can be usually included in a “round shape” as recognized by those skilled in the art while being changed from the perfect circular shape. For example, not only a circle or a perfect circle but also a circle whose arc has a locally different curvature may be used, and furthermore, a circle such as an ellipse or a shape derived from a perfect circle may be used. The cavity of the cup-shaped exterior member 51 may be, for example, circular. The term “circle” as used herein is the same as the term “circle” described for the cup-shaped exterior member.

The term “lid-shaped exterior member” as used herein means a member provided so as to cover the cavity of the cup-shaped exterior member. As illustrated in FIG. 2, the lid-shaped exterior member may be provided with an external output terminal 60 and an insulating member 70. As illustrated in FIG. 2, the lid-shaped exterior member 52 may have, for example, a circular shape. The term “circle” as used herein is the same as the term “circle” described for the cup-shaped exterior member.

The “cavity of the cup-shaped exterior member” as used in the present specification may be, for example, circular in plan view. The term “circle” as used herein is the same as the term “circle” described for the cup-shaped exterior member.

The phrase “providing a lid-shaped exterior member so as to be fitted into at least a part of the cavity of the cup-shaped exterior member” as used in the present specification means that the lid-shaped exterior member is provided such that a predetermined portion (part) of the cup-shaped exterior member forming the cavity by the fitting and at least a part of the lid-shaped exterior member face each other. The phrase “face each other” may mean that, for example, the extending surface of the cup-shaped exterior member and the extending surface of the lid-shaped exterior member have a relationship of being substantially parallel to each other. As illustrated in FIG. 1D, the entire lid-shaped exterior member may be fitted into the cavity of the cup-shaped exterior member.

The term “first extending surface” as used in the present specification means the extending surface of each of the cup-shaped exterior member 51 and the lid-shaped exterior member 52 constituting the boundary portion 53 between the cup-shaped exterior member 51 and the lid-shaped exterior member 52. Specifically, as illustrated in FIG. 2, the first extending surface 51a of the cup-shaped exterior member 51 means the extending surface of the cup-shaped exterior member 51 at the boundary portion 53. The first extending surface 52a of the lid-shaped exterior member 52 means an extending surface of the lid-shaped exterior member 52 at the boundary portion 53. In one aspect, as illustrated in FIG. 2, in the boundary portion 53, the first extending surface 51a of the cup-shaped exterior member 51 and the first extending surface 52a of the lid-shaped exterior member 52 face each other in proximity to or in contact with each other.

The term “second extending surface” as used in the present specification refers to an extending surface of the cup-shaped exterior member 51 on a side not constituting the boundary portion 53 or an extending surface of the lid-shaped exterior member 52 on a side opposite to a forming side of the first extending surface. Specifically, as illustrated in FIG. 2, the second extending surface 51b of the cup-shaped exterior member 51 means an extending surface that is separated from and faces the first extending surface 51a of the cup-shaped exterior member 51. The second extending surface 52b of the lid-shaped exterior member 52 means an extending surface faces the first extending surface 52a of the cup-shaped exterior member 52 while being spaced apart from each other. In one aspect, as illustrated in FIG. 2, the first extending surface and the second extending surface of each exterior member may be in a parallel relationship with each other. The term “parallel” as used herein can mean that, for example, the separation distance between the first extending surface and the second extending surface is substantially constant in the plane direction.

The term “spaced apart” as used in the specification means that an object and an object are spaced apart from each other and are physically and spatially discontinuous to each other. That is, “face . . . while being spaced apart from each other” indicates that an object and an object are positioned to be opposed to each other and the object and the object are spaced apart from each other. For example, as illustrated in FIG. 2, the first extending surface 51a of the cup-shaped exterior member 51 faces the second extending surface 51b of the cup-shaped exterior member 51 while being spaced apart from each other by the thickness of the cup-shaped exterior member 51. The first extending surface 51a of the cup-shaped exterior member 51 faces the second extending surface 51b of the cup-shaped exterior member 51 while being spaced from each other.

In an embodiment, each of the cup-shaped exterior member 51 and the lid-shaped exterior member 52 includes first extending surfaces 51a and 52a constituting the boundary portion 53 and second extending surfaces 51b and 52b facing the first extending surfaces 51a and 52a while being spaced from each other. The welded portion 20 is formed by irradiating the second extending surface of one of the cup-shaped exterior member 51 and the lid-shaped exterior member 52 with the laser L with the boundary portion 53 interposed between the cup-shaped exterior member 51 and the lid-shaped exterior member 52 toward the second extending surface of the other.

Specifically, when the laser L is incident on one second extending surface of the cup-shaped exterior member 51 and the lid-shaped exterior member 52, the welded portion 20 is first formed on a laser incident portion L1 on the one second extending surface. Thereafter, the welded portion 20 can be formed while passing through the boundary portion 53 between the cup-shaped exterior member 51 and the lid-shaped exterior member 52 and extending toward the other second extending surface. That is, the welded portion 20 can be formed while the laser L enters one of the cup-shaped exterior member 51 and the lid-shaped exterior member 52, passes through the boundary portion 53, and extends toward the other of the cup-shaped exterior member 51 and the lid-shaped exterior member 52. Finally, the welded portion 20 can be formed so as to connect both the cup-shaped exterior member 51 and the lid-shaped exterior member 52.

According to the above feature, the laser L is not emitted along the extending direction of the boundary portion 53 between the cup-shaped exterior member 51 and the lid-shaped exterior member 52. As a result, the following effects can be obtained.

Conventionally, in manufacturing the exterior body 50′ of the secondary battery, the laser L′ is emitted along the extending direction of the boundary portion 53′ between the cup-shaped exterior member 51′ and the lid-shaped exterior member 52′ to form the welded portion 20′. That is, the boundary portion 53′ becomes a laser incident portion L1′. Therefore, the sputter 90′ generated at the time of forming the welded portion 20′ easily enters the electrode assembly 10′ with the boundary portion 53′ interposed therebetween.

In an embodiment, the welded portion 20 can be formed by irradiating the second extending surface of one of the cup-shaped and lid-shaped exterior members with the laser L with the boundary portion 53 interposed therebetween toward the second extending surface of the other of the cup-shaped and lid-shaped exterior members. That is, the laser L is not emitted along the extending direction of the boundary portion between the cup-shaped exterior member 51 and the lid-shaped exterior member 52. Therefore, it is possible to prevent the sputter generated at the time of forming the welded portion 20 from entering the electrode assembly 10.

The irradiation direction of the laser L may be any direction as long as the laser L can be emitted in a direction intersecting the extending direction of the boundary portion 53. The intersecting direction means a direction perpendicular or non-perpendicular to the second extending surface 51b of the cup-shaped exterior member 51 and/or the second extending surface 52b of the lid-shaped exterior member 52 in a sectional view. For example, as illustrated in FIG. 2, the irradiation may be performed from the outer peripheral side of the cup-shaped or lid-shaped exterior member toward the inner peripheral side with the boundary portion interposed therebetween, and as illustrated in FIG. 3, the irradiation may be performed from the inner peripheral side of the cup-shaped or lid-shaped exterior member toward the outer peripheral side with the boundary portion interposed therebetween.

The present technology can further achieve the following effects according to an embodiment.

In an embodiment, as described above, the laser L can be emitted from the second extending surface of one of the cup-shaped exterior member 51 and the lid-shaped exterior member 52 toward the second extending surface of the other of the cup-shaped exterior member 51 and the lid-shaped exterior member 52 via the boundary portion 53. In such an embodiment, it is difficult for the irradiation direction of the laser L to be directed toward the electrode assembly Therefore, although when the irradiation range of the laser L and/or the strength of the laser L are increased in order to form the welded portion more reliably, the formed welded portion is less likely to be directed toward the electrode assembly 10, and thus, there is a low possibility that the sputter 90 enters the electrode assembly 10. For example, although when the intensity of the laser L is relatively increased with respect to the thickness of the cup-shaped and lid-shaped exterior members, the sputter 90 is less likely to enter the electrode assembly 10.

In addition, as illustrated in FIG. 1, since the laser L is emitted so as not to be along the extending direction of the boundary portion 53, the laser L is not emitted toward the electrode assembly 10. In other words, it is difficult to form a welded portion toward the electrode assembly 10. Therefore, the irradiation heat of the laser L forming the welded portion is also hardly transmitted toward the electrode assembly 10. That is, the propagation of the irradiation heat of the laser L to the electrode assembly 10 can also be prevented, the strength of the laser L can be increased to firmly form the welded portion and the exterior body 50 is less likely to be separated into the lid-shaped and cup-shaped exterior members due to an impact or the like. In addition, since it is possible to prevent damage to the electrode assembly 10 due to the irradiation heat of the laser L, it is possible to prevent deterioration of performance characteristics of the secondary battery.

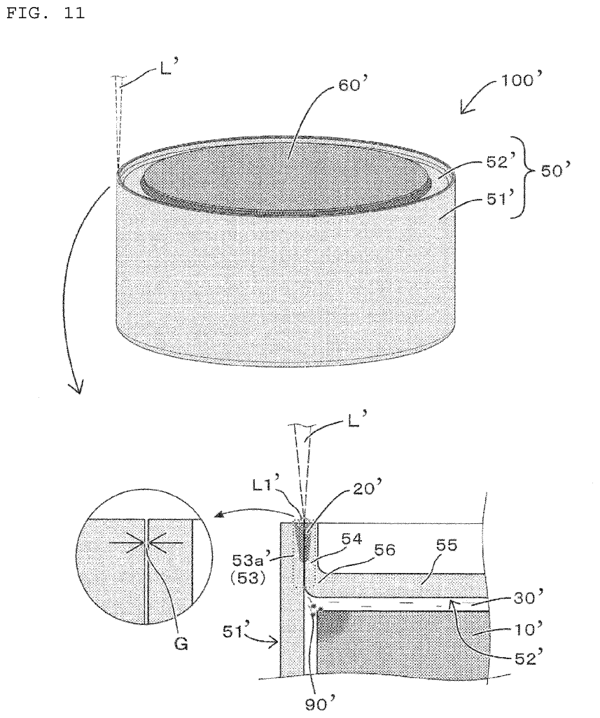

Furthermore, in an embodiment, as illustrated in FIG. 11, although when there is a gap G at the boundary portion 53′ between the cup-shaped and lid-shaped exterior members, since the laser L′ is not emitted along the extending direction of the boundary portion 53′, there is a low possibility that the sputter 90 enters the electrode assembly 10′ with a gap G interposed therebetween. Therefore, a countermeasure for preventing the gap G from being generated, for example, a highly accurate design dimension for the cup-shaped and lid-shaped exterior members is not required.

In the manufacturing of a conventional exterior body of a secondary battery, a welded portion 20′ is formed at an end portion, particularly an end surface, of a cup-shaped and lid-shaped exterior member. When the welded portion 20′ is formed on the end surface, the flatness (or smoothness) increases since the end surface is uneven due to the welded portion 20. In this regard, in an embodiment, since the end surface is not irradiated with the laser L, a state in which flatness and parallelism of the end surface are small can be continuously maintained after the formation of the welded portion 20. As a result, variations in the height of the obtained secondary battery can be suppressed.

In an embodiment, since the above-described effects can be exhibited, it is possible to design a product having a small variation in height of the secondary battery, a small flatness/parallelism of the end surface of the end portion of the exterior member, and a small dimensional tolerance in packaging for reducing the size and thickness of the secondary battery.

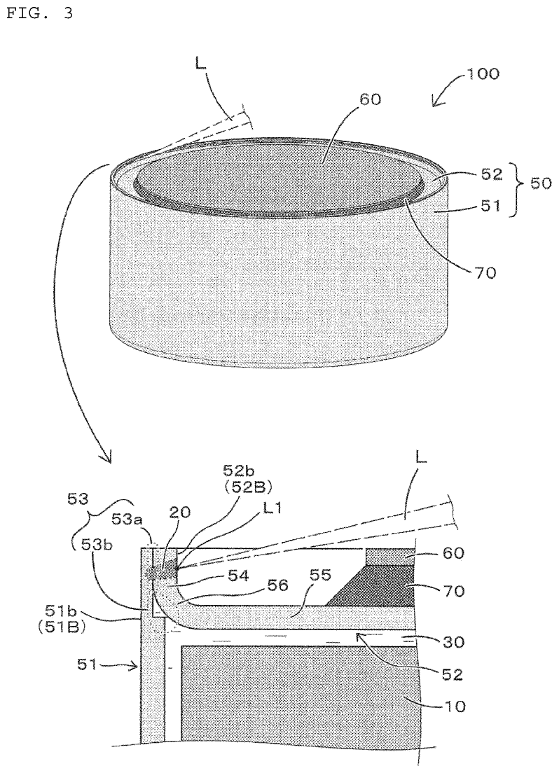

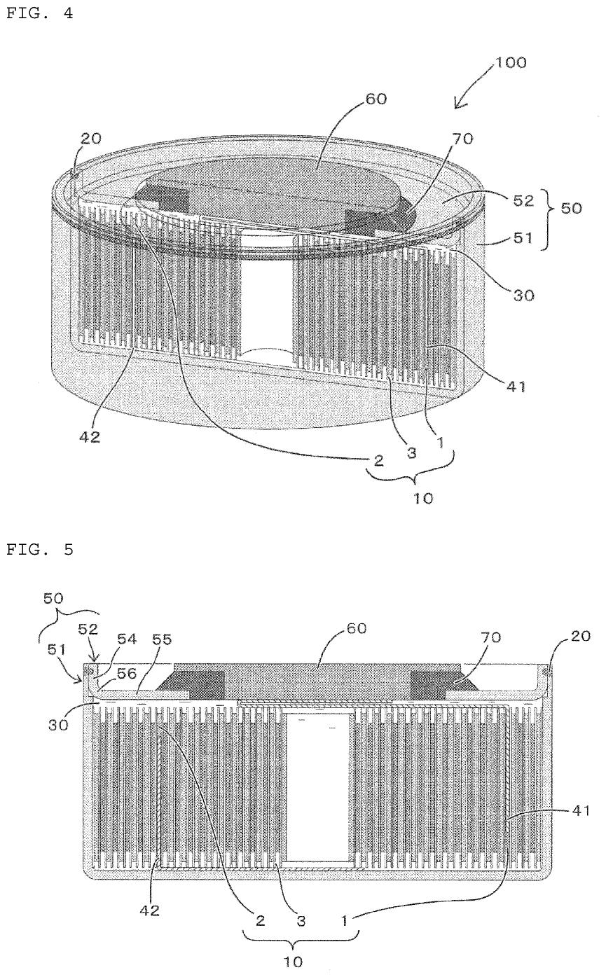

Hereinafter, a secondary battery obtained by the method of manufacturing a secondary battery according to an embodiment including the above-described step (iv) is specifically described with reference to FIGS. 4 and 5.

FIG. 4 is a schematic perspective view illustrating a specific configuration of a secondary battery obtained in accordance with the method of manufacturing a secondary battery according to an embodiment. FIG. 5 is a schematic sectional view illustrating a specific configuration of a secondary battery obtained in accordance with the method of manufacturing a secondary battery according to an embodiment. As illustrated in FIGS. 4 and 5, the secondary battery 100 obtained by the above-described manufacturing method according to an embodiment includes an electrode assembly 10 and an exterior body 50 that houses the electrode assembly 10.

The exterior body 50 includes a cup-shaped exterior member 51 and a lid-shaped exterior member 52 connected to each other by a welded portion 20. The welded portion 20 is formed so as to connect the boundary portion 53 between the cup-shaped exterior member 51 and the lid-shaped exterior member 52 without welding the end portions of the cup-shaped exterior member and the lid-shaped exterior member. As described above, in an embodiment, the welded portion 20 is formed by irradiating the second extending surface of one of the cup-shaped and lid-shaped exterior members with the laser L with the boundary portion 53 interposed therebetween toward the second extending surface of the other of the cup-shaped and lid-shaped exterior members. That is, the laser L is not emitted along the extending direction of the boundary portion 53. Therefore, as compared with the boundary portion 53′ of the conventional secondary battery 100′, the welded portion is not formed at the end portion of the lid-shaped and cup-shaped exterior member of the boundary portion 53, and thus, the boundary surface between the end portion of the lid-shaped exterior member 52 and the end portion of the cup-shaped exterior member 51 may remain. In addition, since the conventional secondary battery emits laser along the boundary portion 53′, the welded portion 20′ is formed at the end portion of the lid-shaped and cup-shaped exterior members of the boundary portion 53′ of the conventional secondary battery 100′. As a result, the flatness of the surface of the exterior member around the boundary portion 53′ is lost, and the surface of the exterior member may be uneven. In this regard, the welded portion 20 is not formed around the end portions of the cup-shaped and lid-shaped exterior members of the secondary battery 100 of the present application, and flatness can be maintained. The term “end portion of the cup-shaped exterior member” as used in the present specification means a terminal portion or an edge portion of the cup-shaped exterior member where no welded portion is formed. The same applies to the “end portion of the lid-shaped exterior member”.

The secondary battery 100 obtained may be a coin-type secondary battery. The coin-type secondary battery typically has a substantially circular shape in plan view. The coin-type secondary battery does not need to be substantially circular in plan view, and may have a deformed shape including a straight portion in a part thereof (for example, a D shape in plan view). When the secondary battery has a substantially circular shape in plan view, the electrode assembly 10 and/or the exterior body 50 including the electrode assembly may also have a substantially circular shape in plan view. The “substantially circular shape (substantially circular)” as used herein is not limited to a perfect circular shape (that is, simply “circle” or “perfect circle”). The curvature of the arc of the substantially circular shape may be locally different. For example, the shape may be a circle such as an ellipse, a shape derived from a true circle, or an oval. The size of the coin-type secondary battery is typically small, and the thickness thereof is smaller than the diameter or width of the coin-type secondary battery. The “coin-type” secondary battery is merely referred to as “coin-type” by those skilled in the art because the appearance described above is an appearance like “coin-type” appearance. Therefore, the coin-type secondary battery may be variously renamed, depending on the appearance, a button battery, a micro battery, or a tubular battery, an oblate battery, a flat battery, a leveled battery, a cylindrical battery, or the like. That is, when the battery has the shape and appearance as described above, the battery can be referred to as a “coin-type” secondary battery, for example. The obtained battery may be a cylindrical can type secondary battery. The size of a cylindrical can type secondary battery is typically small, and the height is larger than a diameter or lateral width of the cylindrical can type secondary battery.

Hereinafter, possible modes of the manufacture method of the present application will be specifically described according to an embodiment.

In an embodiment, the second extending surface is preferably a side surface 51B of the cup-shaped exterior member 51 and a side surface 52B of the lid-shaped exterior member 52 (refer to FIGS. 1A to 1D, FIG. 2, FIG. 3, and the like). The term “side surface” as used in the present specification means a surface extending in a direction relatively perpendicular to an upper surface or a lower surface. The side surface 51B of the cup-shaped exterior member 51 in the present specification may be, for example, as illustrated in FIG. 2, a surface that forms a cavity of the cup-shaped exterior member 51, and may be a surface that extends in a direction substantially perpendicular to the bottom surface (or lower surface) of the cup-shaped exterior member 51. The side surface 52B of the lid-shaped exterior member 52 in the present specification may be, for example, a surface extending in a direction substantially perpendicular to the bottom portion of the lid-shaped exterior member 52 as illustrated in FIG. 2.

By employing such a form, the laser L can be emitted toward the second extending surface which is the “side surface”, so that the welded portion 20 can be easily formed by the irradiation with the laser L. For example, after the cup-shaped exterior member 51 is installed in a smooth place, the cavity is covered with a lid, and the lid-shaped exterior member is provided so that at least a part thereof is fitted into the cavity, the cup-shaped exterior member 51 is rotated to irradiate the second extending surface positioned on the “side surface” with the laser L having the fixed irradiation direction.

When the laser L penetrates the cup-shaped exterior member 51 or the lid-shaped exterior member 52 at the time of forming the welded portion 20 by irradiation with the laser L, the sputter 90 may adhere to the surface of the exterior member around the penetration destination. When the sputter 90 adheres to the surface of the exterior body after the formation of the welded portion 20, the sputter 90 adhered can be a so-called “caught portion”. In particular, when the sputter 90 adheres to the surface on the outer peripheral side of the cup-shaped exterior member 51, there is a possibility that other secondary batteries are damaged by the “caught portion” in a step after the formation of the welded portion 20, for example, a transportation step by a belt conveyor, a packaging step in a container, or the like. In addition, when the sputter 90 adheres to the surface on the outer peripheral side of the exterior body, the surface becomes uneven, so that the appearance may be impaired.

From the viewpoint of preventing the problem caused by the sputter 90 adhering to the surface of the exterior body in an embodiment, it is preferable to emit the laser L from the outer peripheral side of the cup-shaped exterior member 51 or the lid-shaped exterior member 52 toward the inner peripheral side with the boundary portion interposed therebetween. By adopting such a form, when the laser L penetrates each exterior member, the sputter 90 can adhere to the inner peripheral side of the cup-shaped exterior member 51 or the lid-shaped exterior member 52. That is, it is possible to prevent the sputter 90 from adhering to the surface on the outer peripheral side of the cup-shaped exterior member 51 or the lid-shaped exterior member 51.

In an embodiment, each of the cup-shaped and lid-shaped exterior members may further include a third extending surface connecting an end portion of the first extending surface and an end portion of the second extending surface, and the second extending surface of the cup-shaped or lid-shaped exterior member may be irradiated with the laser L such that the welded portion 20 is formed to be spaced apart from the third extending surface of the cup-shaped or lid-shaped exterior member. In other words, the irradiation may be performed so that the laser L does not directly cross the third extending surface.

The term “third extending surface” as used in the present specification means an extending surface that directly connects respective end portions of the first extending surfaces 51a and 52a of the cup-shaped exterior member 51 and the lid-shaped exterior member 52 and respective end portions of the second extending surfaces 51b and 52b facing the first extending surfaces 51a and 52a while being spaced apart from each other. In this case, the thickness of the third extending surface corresponds to the thickness of the cup-shaped exterior member 51 and the lid-shaped exterior member 52. For example, as illustrated in FIG. 2, the third extending surface 51c of the cup-shaped exterior member 51 directly connects the end portion of the first extending surface 51a of the cup-shaped exterior member and the end portion of the second extending surface 51b of the cup-shaped exterior member. The third extending surface 52c of the lid-shaped exterior member 52 directly connects the end portion of the first extending surface 51a of the lid-shaped exterior member 52 and the end portion of the second extending surface 51b of the lid-shaped exterior member 52.

By employing such a form, when the welded portion 20 is formed by irradiation with the laser L, the welded portion 20 can be prevented from being formed on the third extending surface of each of the cup-shaped exterior member 51 and the lid-shaped exterior member 52. When the welded portion 20 is formed on the third extending surface, the third extending surface is uneven due to the welded portion and it is difficult to maintain flatness. In addition, when the welded portion 20 is formed, “shrinkage” may occur in which each molten exterior member is greatly deformed by surface tension. When “shrinkage” occurs, a caught portion may be formed in the peripheral portion of the end surface or the product dimension may change, which may cause unstable quality.

The third extending surface may be, for example, an end surface of an end portion of the cup-shaped exterior member 51 and/or the lid-shaped exterior member 52. The “end surface of the end portion” as used herein may be, for example, a two-dimensional surface forming an edge end of the cup-shaped exterior member 51. In other words, among the main surfaces forming the cup-shaped exterior member 51, the surface may be a surface that connects an end portion of one main surface and an end portion of the other main surface. The above can also be applied to the lid-shaped exterior member 52. Also by adopting such a form, it is possible to obtain the same effect as when the laser L is emitted toward the cup-shaped or lid-shaped second extending surface so that the welded portion 20 is formed to be spaced apart from the third extending surface of the cup-shaped or lid-shaped exterior member.

In FIG. 2 and the like, each of the third extending surface 51c of the cup-shaped exterior member and the third extending surface 52c of the lid-shaped exterior member 52 is a flat surface, but other surface forms may also be employed. For example, the third extending surface 51c of the cup-shaped exterior member and/or the third extending surface 52c of the lid-shaped exterior member 52 may be formed of a curved surface, an inclined surface, or a plurality of surfaces. In an embodiment, since the laser L is emitted toward the cup-shaped or lid-shaped second extending surface so that the welded portion 20 is formed to be spaced apart from the third extending surface, the quality of the welded portion to be formed is easily made constant regardless of the form of the third extending surface. In other words, in an embodiment, regardless of the form (for example, as described below, it is difficult to make the welding quality constant in the related art) of the third extending surface, the welded portion 20 can be formed while preventing such welding of the third extending surface.

Examples of the third extending surface in a form in which it is difficult to make the welding quality constant include a positional relationship in which the third extending surfaces 51c and 52c of the cup-shaped exterior member and the lid-shaped exterior member are not on a straight line (that is, not flush) with each other. Alternatively, there is a positional relationship in which the third extending surfaces 51c and 52c of the cup-shaped exterior member and the lid-shaped exterior member are spaced apart from each other, and a gap is generated between the third extending surfaces 51c and 52c. When the respective exterior members including the third extending surface in the above form are welded, it is difficult for the shape of the welded portion to be formed to be constant. In an embodiment, regardless of the third extending surface of the above form, the quality of the welded portion 20 to be formed can be easily made constant by emitting the laser L so as to form the welded portion 20 spaced apart from the third extending surface.

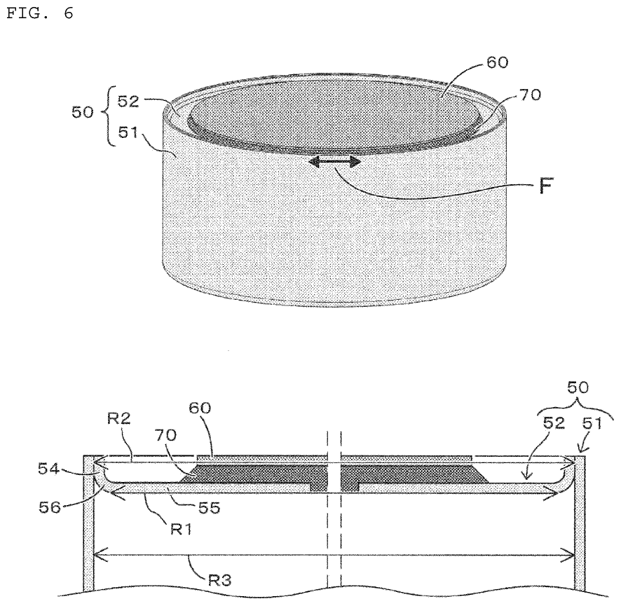

In an embodiment, as illustrated in FIG. 6, as the lid-shaped exterior member 52 in a sectional view, an exterior member having a bottom portion 55 and a rising side portion 54 configured to rise from an outer peripheral edge of the bottom portion 55, and having an outer curved surface 56 formed of the bottom portion 55 and the rising side portion 54 may be used.

In the present specification, the “rising side portion” refers to a portion where the outer peripheral edge of the lid-shaped exterior member 52 rises with respect to the bottom portion 55. Also, as a general appearance, the raised portion may be viewed as a side relative to the bottom portion 55, and thus the raised portion may be referred to as a “rising side portion”.

The term “outside” in the present specification refers to, for example, an outer peripheral side of the lid-shaped exterior member 52. Regarding the “outer peripheral side”, it can be said that, of two surfaces defining the thickness of the lid-shaped exterior member 52 and facing each other while being spaced apart from each other, the surface on the distal side as viewed from the space side surrounded by the bottom portion 55 and the rising side portion 54 is the “outer peripheral side”, and the surface on the proximal side is the “inner peripheral side”. The “outer curved surface” means a curved surface curved so as to be convex in the direction of the outer peripheral side of the lid-shaped exterior member 52.

As illustrated in FIG. 6, the diameter of the lid-shaped exterior member 52 in which the outer curved surface 56 is formed of the bottom portion 55 and the rising side portion 54 can employ the following configuration due to the presence of the outer curved surface 56 curved in an R shape. Specifically, as illustrated in FIG. 6, in the lid-shaped exterior member 52, an outer diameter R2 of the cavity of the lid-shaped exterior member 52 is larger than a diameter R1 of the bottom portion 55 of a flat plate portion not including the curved portion. The diameter R1 of the bottom portion 55 is smaller than an inner diameter R3 of the cavity of the cup-shaped exterior member 52. The inner diameter R3 of the cavity of the cup-shaped exterior member 52 and the outer diameter R2 of the cavity of the lid-shaped exterior member may be substantially the same. In other words, each of the inner diameter R3 of the cavity of the cup-shaped exterior member 52 and the outer diameter R2 of the cavity of the lid-shaped exterior member may have a size in which the lid-shaped exterior member 52 can be fitted into the cavity of the cup-shaped exterior member 51. In such a form, when the lid-shaped exterior member 52 is provided so as to cover the cavity of the cup-shaped exterior member 51, the bottom portion 55 of the lid-shaped exterior member 52 is easily positioned in the cavity of the cup-shaped exterior member 51.

In addition, the rising side portion 54 of the lid-shaped exterior member 52 has a form in which an end portion is a free end and is continuous with the outer curved surface 56 before being fitted into the cup-shaped exterior member 51. Further, the outer diameter R2 of the cavity of the lid-shaped exterior member 52 is slightly larger than the inner diameter R3 of the cavity of the cup-shaped exterior member 51. Since such a configuration is employed, at the time of fitting, the outer diameter R2 of the cavity of the lid-shaped exterior member 52 may change so as to approach the inner diameter R3 of the cavity of the cup-shaped exterior member having a diameter slightly smaller than R2. As a result, at the time of fitting, the rising side portion 54 can be deformed relatively inward from the outer curved surface 56 as a starting point. As a result, the rising side portion 54 of the lid-shaped exterior member 52 can be deformed such that the inner diameter R3 and the outer diameter R2 are substantially the same. This means that since the rising side portion 54 of the lid-shaped exterior member 52 has the “outer curved surface”, the exterior members can be fitted into each other although the cup-shaped exterior member 51 and the lid-shaped exterior member 52 do not have highly accurate design dimensions.

When the lid-shaped exterior member 52 is fitted into the cup-shaped exterior member 51 under the above conditions, the outer peripheral diameter of the cup-shaped exterior member 51 in the portion in contact with the lid-shaped exterior member 52 may be larger than the outer peripheral diameter of the portion in which the lid-shaped exterior member 52 of the bottom portion 55 of the lid-shaped exterior member 52 and the cup-shaped exterior member 51 are not in contact.

Furthermore, when the lid-shaped exterior member 52 including the rising side portion 54 including the “outer curved surface” is fitted into the cup-shaped exterior member 51, a stress F may act by fitting the lid-shaped exterior member 52 to the outer peripheral edge forming the cavity of the cup-shaped exterior member 51. More specifically, the stress F can act in the circumferential direction of the cavity of the cup-shaped exterior member 51.

These are generated because the outer peripheral edge forming the cavity of the cup-shaped exterior member 51 is expanded in the circumferential direction of the cavity by the lid-shaped exterior member 52 fitted as described above. With such a form, it is possible to improve the sealing property when the lid-shaped exterior member 52 is provided so as to cover the cavity of the cup-shaped exterior member 51 and to be fitted into at least a part of the cavity. In addition, due to the presence of the rising side portion 54 of the lid-shaped exterior member 52, the facing portion between the cup-shaped exterior member 51 and the lid-shaped exterior member 52 at the time of fitting increases, which can contribute to improvement of the sealing property.

With such a form, the lid-shaped exterior member 52 can be held by the cup-shaped exterior member 51 only by fitting. As a result, when the welded portion 20 is formed by the irradiation with the laser L, a step of preparing and fixing a new jig for preventing the lid-shaped exterior member 52 from deviating from the welding position and/or a step of spot-welding and fixing a part of the boundary portion 53 of each exterior member are unnecessary, and the welding step can be simplified.

Furthermore, with such a form, the boundary surface between the cup-shaped exterior member and the lid-shaped exterior member can be brought into contact with each other without a gap only by fitting the lid-shaped exterior member 51 into the cup-shaped exterior member 52 before forming the welded portion 20 by irradiation with the laser L. Specifically, by making the outer shape R2 of the lid-shaped exterior member 51 larger than the inner diameter R3 of the cup-shaped exterior member 52, by “pushing” the lid-shaped exterior member 51 into the cup-shaped exterior member 52, the main surface including the rising side portion 54 including the outer curved surface 56 of the lid-shaped exterior member 51 can be pressed against the cup-shaped exterior member 52. By pressing, a boundary surface between the cup-shaped exterior member and the lid-shaped exterior member can be brought into contact with each other without a gap, and a state in which the lid-shaped exterior member 51 is fitted into the cup-shaped exterior member 52 can be maintained. As a result, it is not necessary to provide fixing means for preventing the lid-shaped and cup-shaped exterior members from moving before the irradiation with the laser L, which can contribute to simplification of the method of manufacturing the secondary battery. Further, by adjusting the depth of “pushing”, the end surface of the end portion of the lid-shaped exterior member 51 can be easily positioned so as to be flush with the end surface of the end portion of the cup-shaped exterior member 52.

When the lid-shaped exterior member 51 having the rising side portion 54 including the outer curved surface 56 in the sectional view is used, the external output terminal 60 may be further provided on the lid-shaped exterior member 51. In a sectional view, the lid-shaped exterior member 51 having the rising side portion 54 including the outer curved surface 56 has a recessed structure like a bowl. Therefore, for example, although when the external output terminal 60 is installed on the lid-shaped exterior member 51, the external output terminal is accommodated in the recessed structure of the lid-shaped exterior member 51, so that the external output terminal 60 does not protrude in a convex shape from the lid-shaped exterior member 51 when viewed as the entire secondary battery. In addition, since the internal volume of the secondary battery can be maximized, the volume energy density of the secondary battery can be maximized.

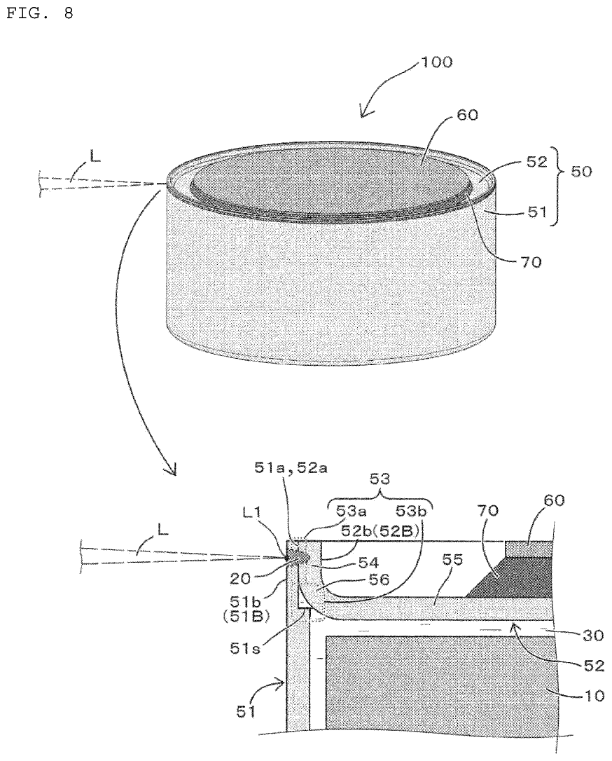

In an embodiment, as illustrated in FIG. 8, as the lid-shaped exterior member 52 and the cup-shaped exterior member 51, a member in which a step 51S is provided on the inner peripheral side of at least one of the lid-shaped exterior member 52 and the cup-shaped exterior member 51 may be used.

With such a form, when the lid-shaped exterior member 52 is provided so as to cover the cavity of the cup-shaped exterior member 51 and to be fitted into at least a part of the cavity, the lid-shaped exterior member 52 can be brought into contact with and engaged with the step 51S as illustrated in FIG. 8. Thus, the insertion depth of the lid-shaped exterior member 52 into the cup-shaped exterior member 51 can be limited. In other words, the insertion depth of the lid-shaped exterior member 52 into the cup-shaped exterior member 51 can be positioned constant. That is, the cup-shaped exterior member 51 can function as an insertion depth limiting mechanism of the lid-shaped exterior member 52. As a result, the quality of the manufactured exterior body 50 can be stabilized, and the manufacturing yield of the secondary battery can be improved.

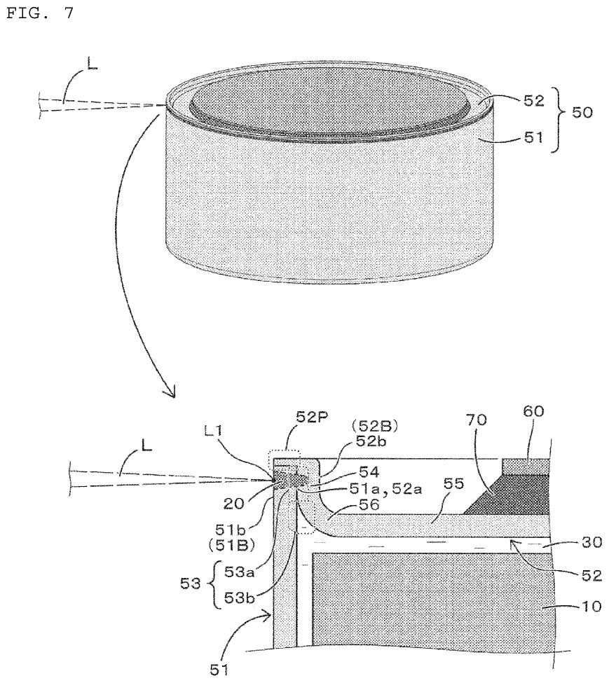

In an embodiment, it is preferable that the boundary portion 53 has a contact region 53a where the cup-shaped exterior member 51 and the lid-shaped exterior member 52 are in contact with each other, and the contact region 53a is irradiated with the laser L. Specifically, as illustrated in FIG. 7, when the lid-shaped exterior member 52 having the rising side portion 54 including the outer curved surface 56 is used, the contact region 53a where the cup-shaped exterior member 51 and the lid-shaped exterior member 52 are in contact with each other and the separation region 53b where the cup-shaped exterior member and the lid-shaped exterior member are spaced apart from each other exist in the boundary portion 53. Among the contact region 53a and the separation region 53b, it is preferable to irradiate the second extending surface of one of the cup-shaped and lid-shaped exterior members with the laser L through the contact region 53a toward the second extending surface of the other of the cup-shaped and lid-shaped exterior members.

In the case of forming the welded portion 20 by irradiation with the laser L, when the laser L is emitted toward the separation region 53b, the welded portion 20 is formed so as to be exposed to the inside of each exterior sealing structure, so that the possibility that the sputter enters the electrode assembly 10 increases. In this regard, by irradiating the contact region 53a of the boundary portion 53 with the laser L, it is possible to prevent the sputter from entering the electrode assembly In addition, as described above, since the lid-shaped exterior member 52 having the rising side portion 54 including the outer curved surface 56 is used, the sealing property can also be improved.

In an embodiment, as illustrated in FIG. 7, as the lid-shaped exterior member 52, a member formed by further including a protruding portion 52p continuous with the rising side portion 54 of the lid-shaped exterior member 52 and extending in a direction different from the extending direction of the rising side portion 54 may be used. In other words, the lid-shaped exterior member 52 may have the “third extending surface 52c of the lid-shaped exterior member 52” further including the protruding portion 52p protruding to the outer peripheral side of the lid-shaped exterior member 52. With such a form, the protruding portion 52p is brought into contact with the end portion of the cup-shaped exterior member 51. As illustrated in FIG. 7, when the protruding portion 52p is brought into contact with the end portion of the cup-shaped exterior member 51, the protruding portion 52p can be engaged with the end portion of the cup-shaped exterior member 51. Thus, the insertion depth of the lid-shaped exterior member 52 into the cup-shaped exterior member 51 can be limited. In other words, when the cavity of the cup-shaped exterior member 51 is covered with the lid and the lid-shaped exterior member 52 is provided such that at least a part thereof is fitted into the cavity, the insertion depth of the lid-shaped exterior member 52 can be positioned constant. That is, the cup-shaped exterior member 51 can function as an insertion depth limiting mechanism of the lid-shaped exterior member 52. Since the protruding portion 52p is positioned so as to cover the end surface of the end portion of the cup-shaped exterior member 51, the boundary portion 53 between the cup-shaped exterior member 51 and the lid-shaped exterior member 52 is not exposed to the outside. Therefore, the flatness of the end surface of the end portion of the manufactured exterior body 50 can be improved.

From the viewpoint of increasing the volume energy density of the secondary battery, the thicknesses of the cup-shaped exterior member 51 and the lid-shaped exterior member 52 may be reduced. Specifically, the thickness of the cup-shaped exterior member 51 may be 10 μm or more and 500 μm or less, and may be, for example, 10 μm or more and 300 μm or less, 10 μm or more and 150 μm or less, 10 μm or more and 100 μm or less, or 10 μm or more and 75 μm or less. The thickness of the lid-shaped exterior member 52 may be 10 μm or more and 500 μm or less, and may be, for example, 10 μm or more and 300 μm or less, 10 μm or more and 150 μm or less, or 10 μm or more and 75 μm or less.

As described above, the volume energy density of the secondary battery can be increased by reducing the thickness of the exterior member. However, by reducing the thickness of the exterior member, the exterior member is easily “shrunk” by melting when the welded portion 20 is formed. In particular, in a case where “shrinkage” occurs when the end portion of the cup-shaped and lid-shaped exterior members 52 is irradiated with the laser L, it may cause formation of a caught portion due to “shrinkage” or variation in product dimensions. Although the occurrence of “shrinkage” can be suppressed by weakening the strength of the laser L, on the other hand, there is a possibility that the formation of the welded portion 20 becomes insufficient, and there is a possibility that the sealing property cannot be secured.

In an embodiment, the laser L is not emitted along the extending direction of the boundary portion 53 between the cup-shaped exterior member 51 and the lid-shaped exterior member 52. Therefore, it is possible to suppress the occurrence of “shrinkage” of the welded portion 20 when the end portion of the cup-shaped and lid-shaped exterior member 52 is irradiated with the laser L, and thus, it is possible to reduce the thickness of the exterior member.

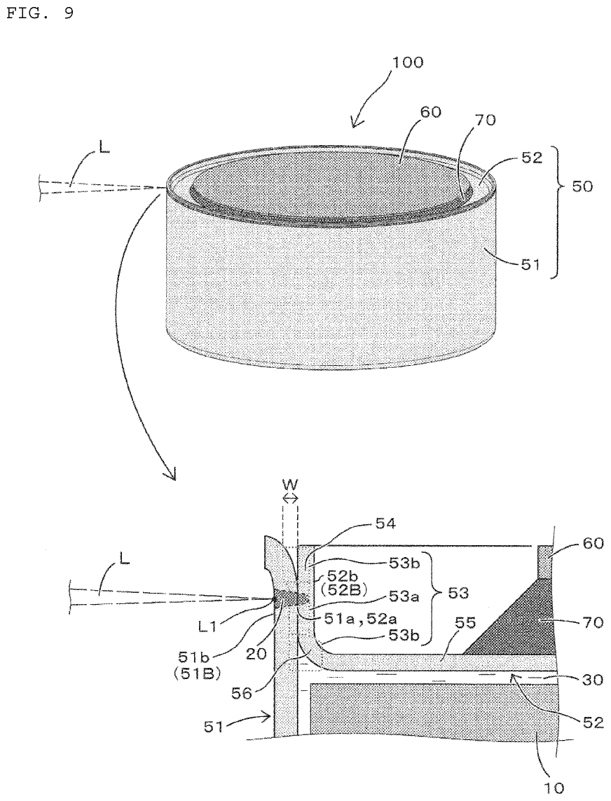

In an embodiment, as illustrated in FIG. 9, as the cup-shaped exterior member 51, a member in which an outer peripheral edge portion of the cup-shaped exterior member is curved such that an end portion of the cup-shaped exterior member is spaced apart from the end portion of the lid-shaped exterior member in a sectional view can be used. Specifically, it means that an outer peripheral edge portion forming a cavity of the cup-shaped exterior member 51 in a sectional view is curved toward the outer peripheral side of the cup-shaped exterior member 51 in an R shape. When the lid-shaped exterior member 52 is fitted into the cup-shaped exterior member 51 in which the outer peripheral edge portion forming the cavity is curved toward the outer peripheral side in an R shape, a gap W is formed between the end portion of the cavity of the cup-shaped exterior member 51 and the end portion of the lid-shaped exterior member 52.

In such a mode, when the laser L is emitted along the extending direction of the boundary portion 53, the sputter generated by the formation of the welded portion 20 further easily enters the electrode assembly because the gap W exists in the boundary portion 53.

As described above, in an embodiment, since the laser L is emitted so as not to be along the direction in which the boundary portion 53 extends, although the welded portion 20 is formed using the cup-shaped exterior member 51 in which the outer peripheral edge portion forming the cavity is curved toward the outer peripheral side of the cup-shaped exterior member 51, the sputter 90 is less likely to enter the electrode assembly 10. For the same reason, “shrinkage” of melting of the end portion of each exterior member can also be prevented.

Furthermore, when the outer peripheral edge portion forming the cavity of the cup-shaped exterior member 51 is curved toward the outer peripheral side of the cup-shaped exterior member 51, the inner diameter of the curved cavity is increased, so that the lid-shaped exterior member 52 can be easily fitted. In addition, in the step of manufacturing the cup-shaped exterior member 51, although when the cup-shaped exterior member 51 in which the outer peripheral edge portion forming the cavity is curved in an R shape is manufactured, according to the present application, the exterior member can be used as it is, so that productivity can be improved.

### EXAMPLES

Hereinafter, examples of the present application will be described according to an embodiment.

### Comparative Example

### (Preparation of Cup-Shaped Exterior Member and Lid-Shaped Exterior Member)

A cup-shaped exterior member and a lid-shaped exterior member were prepared. As the lid-shaped exterior member, one having a bottom portion and a rising side portion configured to rise from an outer peripheral edge of the bottom portion in a sectional view and having an outer curved surface formed of the bottom portion and the rising side portion was used.

A cup-shaped exterior member having an inner diameter of 12 mm and a height of 5.4 mm and a lid-shaped exterior member having an outer diameter of 12.05 mm and an inner peripheral side height of 0.4 mm were prepared. As shown in the table, four thicknesses of 0.3 mm, 0.15 mm, 0.1 mm, and 0.075 mm were prepared for the cup-shaped exterior member and the lid-shaped exterior member.

### (Formation of Exterior Body)

An electrode assembly was provided, a cavity of the cup-shaped exterior member, into which the electrolytic solution was injected, was covered with a lid of the lid-shaped exterior member, and the electrode assembly was inserted so that at least a part thereof was fitted into the cavity (as illustrated in FIG. 2). The insertion depth was set such that the end surfaces of the cup-shaped and lid-shaped exterior members were flush with each other. Thereafter, as illustrated in FIG. 11, welding was performed by irradiating the end surfaces of the cup-shaped and lid-shaped exterior members with laser from the upper direction of the cup-shaped and lid-shaped exterior members toward the end surfaces of the cup-shaped and lid-shaped exterior members along the boundary surfaces of the cup-shaped and lid-shaped exterior members. Thus, the boundary surfaces of the cup-shaped and lid-shaped exterior members were welded to form an exterior body.

### [Measurement of Variation in Side Surface Height Dimension]

As for the side surface height dimension, the maximum value measured at 8 points of each sample using a digimatic indicator (manufactured by Mitutoyo Corporation) of a flat terminal was employed as the side surface height of the sample, and the CV value was obtained by dividing the standard deviation of 32 pieces of data by the average value.

### (Result of Variation in Side Surface Height Dimension of Comparative Example)

Table 1 shows results of variations in side surface height dimension of the comparative example. The cases where the thicknesses of the cup-shaped and lid-shaped exterior members were respectively 0.3 mm, 0.15 mm, 0.1 mm, and 0.075 mm were set as Comparative Example 1, Comparative Example 2, Comparative Example 3, and Comparative Example 4, respectively. As can be seen from Table 1, the value of the variation in side surface height dimension increased as the wall thickness decreased. Specifically, as the thickness decreased, the values of the variations in the side surface height dimension increased to 0.27, 1.5, 1.9, and 2.2, and the values of the variations in the side surface height dimension when the thickness was 0.15 mm were about 5 times, the values of the variations in the side surface height dimension when the thickness was 0.1 mm were about 7 times, and the values of the variations in the side surface height dimension when the thickness was 0.075 mm were about 8 times, in particular, as compared with the results when the thickness was 0.3 mm.

TABLE 1

| | Thick- | Thick- | | |
|---|---|---|---|---|
| | ness | ness | | Variation |
| | of cup- | of lid- | | in side |
| | shaped | shaped | | surface |
| | exterior | exterior | | height |
| | member | member | Irradiation direction | dimension |
| | (mm) | (mm) | of laser | (CV %) |
| Comparative | 0.3 | 0.3 | Irradiating end surface | 0.27 |
| Example 1 | | | from above | |
| Example 1 | | | Irradiating side surface | 0.14 |
| | | | from outer peripheral | |
| | | | side | |
| Comparative | 0.15 | 0.15 | Irradiating end surface | 1.5 |
| Example 2 | | | from above | |
| Example 2 | | | Irradiating side surface | 0.13 |
| | | | from outer peripheral | |
| | | | side | |
| Comparative | 0.1 | 0.1 | Irradiating end surface | 1.9 |
| Example 3 | | | from above | |
| Example 3 | | | Irradiating side surface | 0.15 |
| | | | from outer peripheral | |
| | | | side | |
| Comparative | 0.075 | 0.075 | Irradiating end surface | 2.2 |
| Example 4 | | | from above | |
| Example 4 | | | Irradiating side surface | 0.18 |
| | | | from outer peripheral | |
| | | | side | |

### Examples

As illustrated in FIG. 2, an exterior body was produced under the same conditions as in the comparative example except that welding was performed under the same irradiation conditions by irradiating the side surface of the cup-shaped exterior member with laser from the outer peripheral side (lateral direction) of the side surface of the cup-shaped exterior member, and variations in side surface height dimension were measured by the same method. The cases where the thicknesses of the cup-shaped and lid-shaped exterior members were respectively 0.3 mm, 0.15 mm, 0.1 mm, and 0.075 mm were set as Example 1, Example 2, Example 3, and Example 4, respectively, and the results thereof are shown in Table 1. As can be seen from Table 1, although when the thickness of the cup-shaped and lid-shaped exterior members decreased, the value of the variation in the side surface height dimension hardly changed.

Comparative examples and examples were compared based on the results shown in Table 1. First, when comparing the values of the variation in side surface height dimension (CV%) between Example 1 and Comparative Example 1 in which the thickness of the cup-shaped and lid-shaped exterior members was 0.3 mm, Example 1 was 0.14, and Comparative Example 1 was 0.27. The value of Example 1 was smaller than that of Comparative Example 1, and the value of variation in side surface height dimension of Comparative Example 1 was about twice that of Example 1. When the thickness was 0.15 mm, Example 2 was 0.13, Comparative Example 2 was 1.5, Example 2 was smaller, and the difference between them was about 10 times or more. When the thickness was 0.1 mm, Example 3 was 0.15, Comparative Example 3 was 1.9, Example 3 was smaller, and the difference between them was 10 times or more. When the thickness was 0.075 mm, Example 4 was 0.18, Comparative Example 4 was 2.2, Example 4 was smaller, and the difference between them was 10 times or more. The small value of the variation in the side surface height dimension (CV%) means that the exterior body has a uniform side surface height. That is, it can be said that the example in which welding is performed by irradiating the side surface of the cup-shaped exterior member with laser from the outer peripheral side (lateral direction) of the side surface is an exterior body having a uniform side surface height as compared with the comparative example.

The welded portion formed in examples was formed from the side surface of the cup-shaped exterior member to the side surface of the lid-shaped exterior member, and was not formed on the end surfaces of the cup-shaped and lid-shaped exterior members. This is because welding was performed by irradiating the side surface of the cup-shaped exterior member with laser from the outer peripheral side (lateral direction) of the side surface of the cup-shaped exterior member. Therefore, the end surfaces of the cup-shaped and lid-shaped exterior members was able to maintain the same surface (flush) at the time of insertion. That is, the side surface height was able to be maintained uniform.

On the other hand, the welded portion formed in the comparative example was formed on the boundary surface positioned on the end surfaces of the cup-shaped and lid-shaped exterior members. This is because welding was performed by irradiating the end surfaces of the cup-shaped and lid-shaped exterior members with laser from the upper direction of the cup-shaped and lid-shaped exterior members toward the end surfaces of the cup-shaped and lid-shaped exterior members along the boundary surfaces of the cup-shaped and lid-shaped exterior members. Since the surface of the welded portion was uneven and non-uniform in shape, and the welded portion was formed as a convex portion on the end surface, the height of the side surface of the comparative example in which the welded portion was formed on the end surface of the cup-shaped and lid-shaped exterior members was not uniform.

In addition, in the comparative example, when the welded portion was formed, welding was performed by emitting laser along the boundary surface between the cup-shaped and lid-shaped exterior members as described above. That is, since the welded portion is formed toward the electrode assembly positioned on the inner peripheral side of the exterior body, it has been found that the sputter may enter the electrode assembly. In this regard, in examples, it has been found that there is no possibility that the sputter enters the electrode assembly since the laser is not emitted along the boundary surface between the cup-shaped and lid-shaped exterior members as described above.

As shown in Table 1, the variations (CV%) in the side surface height dimension of the wall thicknesses of 0.15 mm (Comparative Example 2), 0.1 mm (Comparative Example 3), and 0.075 mm (Comparative Example 4) were larger than the wall thickness of 0.30 mm (Comparative Example 1). This is because the heat energy of the laser irradiation received by the exterior member relatively increased due to the reduced wall thickness, so that the entire end surface was melted, and as a result, the end surface was greatly deformed by surface tension. Therefore, it is considered that the dimensional variation of the finished product was increased.

On the other hand, the variations (CV%) in the side surface height dimension of Examples 2, 3, and 4 were similar to those of Example 1, and were smaller than those of the comparative examples. From this, it has been found that although when the thickness of the exterior member is reduced, by forming the welded portion by emitting the laser from the side surface of the exterior member, it is possible to suppress an increase in variation in the side surface height dimension (CV%) and to maintain high dimensional accuracy.

Although one or more embodiments of the present application have been described herein, the present application is not limited thereto, and those skilled in the art will readily understand that various aspects can be conceived.

The secondary battery according to an embodiment of the present application can be used in various fields in which electricity storage is assumed. For example, the secondary battery can be used in the fields of electricity, information, and communication in which electricity, electronic equipment, and the like are used (for example, electric and electronic equipment fields or mobile equipment fields including mobile phones, smartphones, notebook computers and digital cameras, activity meters, arm computers, electronic paper, wearable devices, and small electronic machines such as RFID tags, card type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (medical equipment fields such as earphone hearing aids), pharmaceutical applications (fields such as dosage management systems), IoT fields, space and deep sea applications (for example, the fields of a space probe and a submersible), and the like.

### DESCRIPTION OF REFERENCE SYMBOLS

1: Positive electrode

2: Negative electrode

3: Separator

5: Electrode configuration layer

10, 10′: Electrode assembly

20, 20′: Welded portion

30: Electrolytic solution

41: Positive electrode current collection tab

42: Negative electrode current collection tab

50′: Exterior body

51, 51′: Cup-shaped exterior member

51a: First extending surface (cup-shaped exterior member side)

51B: Side surface of cup-shaped exterior member

51b: Second extending surface (cup-shaped exterior member side)

51c: Third extending surface (cup-shaped exterior member side)

51s: Step

52, 52′: Lid-shaped exterior member

52a: First extending surface (lid-shaped exterior member side)

52B: Side surface of lid-shaped exterior member

52b: Second extending surface (lid-shaped exterior member side)

52c: Third extending surface (lid-shaped exterior member side)

52p: Protruding portion

53: Boundary portion

53a: Contact region

53b: Separation region

54, 54′: Rising side portion

55′: Bottom portion

56: Outer curved surface

60: External output terminal

70: Insulating member

90′Sputter

100, 100′: Secondary battery

F: Stress

G: Gap of boundary portion

L, L′: Laser

L1, L1′: Incident portion of laser

R1: Diameter of bottom portion of flat plate portion not including curved portion of lid-shaped exterior member

R2: External shape of cavity of lid-shaped exterior member

R3: Inner diameter of cavity of cup-shaped exterior member 52

W: Gap between end portion of cup lid-shaped exterior member and end portion of lid-shaped member

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of manufacturing a secondary battery, the method comprising:
providing an electrode assembly in a cup-shaped exterior member;
injecting an electrolytic solution into the cup-shaped exterior member;
providing a lid-shaped exterior member so as to cover a cavity of the cup-shaped exterior member with a lid and to be fitted into at least a part of the cavity; and
irradiating a boundary portion between the cup-shaped exterior member and the lid-shaped exterior member facing each other with laser to form a welded portion, by providing the lid-shaped exterior member,
wherein:
each of the cup-shaped and lid-shaped exterior members includes a first extending surface constituting the boundary portion and a second extending surface facing the first extending surface while being spaced apart from each other, and
the laser is emitted from the second extending surface of one of the cup-shaped and lid-shaped exterior members toward the second extending surface of the other of the cup-shaped and lid-shaped exterior members with the boundary portion interposed therebetween.

2. The method of manufacturing a secondary battery according to claim 1, wherein the laser is emitted across the boundary portion.

3. The method of manufacturing a secondary battery according to claim 1, wherein the laser is emitted so as to cross the boundary portion.

4. The method of manufacturing a secondary battery according to claim 1, wherein the second extending surface is a side surface of the cup-shaped exterior member and a side surface of the lid-shaped exterior member.

5. The method of manufacturing a secondary battery according to claim 1, wherein the one of the second extending surfaces of the cup-shaped and lid-shaped exterior members is a laser incident portion.

6. The method of manufacturing a secondary battery according to claim 1, wherein the laser is emitted from an outer peripheral side of the cup-shaped or lid-shaped exterior member toward an inner peripheral side with the boundary portion interposed therebetween.

7. The method of manufacturing a secondary battery according to claim 1, wherein each of the cup-shaped and lid-shaped exterior members further includes a third extending surface connecting an end portion of the first extending surface and an end portion of the second extending surface, and
the cup-shaped or lid-shaped exterior member is irradiated with the laser such that the welded portion is formed to be spaced apart from the third extending surface of the cup-shaped and lid-shaped exterior member.

8. The method of manufacturing a secondary battery according to claim 1, wherein as the lid-shaped exterior member in a sectional view, an exterior member having a bottom portion and a rising side portion configured to rise from an outer peripheral edge of the bottom portion, and having an outer curved surface formed of the bottom portion and the rising side portion is be used.

9. The method of manufacturing a secondary battery according to claim 8, wherein the boundary portion has at least a contact region where the cup-shaped exterior member and the lid-shaped exterior member are in contact with each other, and the contact region is irradiated with the laser.

10. The method of manufacturing a secondary battery according to claim 1, wherein as the exterior member, a member having a step provided on an inner peripheral side of at least one of the cup-shaped exterior member and the lid-shaped exterior member is used.

11. The method of manufacturing a secondary battery according to claim 8, wherein as the lid-shaped exterior member, a member formed by further including a protruding portion continuous with the rising side portion of the lid-shaped exterior member and extending in a direction different from the extending direction of the rising side portion is used.

12. The method of producing a secondary battery according to claim 1, wherein the cup-shaped exterior member and the lid-shaped exterior member each have a thickness of 300 μm or less.

13. The method of producing a secondary battery according to claim 1, wherein as the cup-shaped exterior member, a member in which an outer peripheral edge portion of the cup-shaped exterior member is curved such that an end portion of the cup-shaped exterior member is spaced apart from the end portion of the lid-shaped exterior member in a sectional view is used.
